(19) United States
(12) Patent Application Publication
(10) Pub. No.: US 2010/0312439 A1
(43) Pub. Date: Dec. 9, 2010

(54) Vehicular (car, truck, bus, van, suv, etc) fuel saving mechanical apparatus for the purpose of increasing the gas mileage by cutting down on the unnecessary gas consumption and by applying the surplus propulsive power automatically being created by a moving vehicle

(76) Inventor: Seongtai Song, (US)

Correspondence Address: Seongtai Song, 146 - 52 28th Ave. #2F, Flushing, NY, 11354, US

(21) Appl. No.: 12/455,589

(22) Filed: Jun. 4, 2009

(51) Int. Cl. G06F 19/00

(52) U.S. Cl. 701/54

(57) ABSTRACT

Vehicular fuel saving mechanical apparatus consisted of supplementary transmission connected to the tires and computerized mechanism of timely reduced fuel injection.

### CROSS-REFERENCE TO RELATED APPLICATIONS

the U.S. application Ser. No. 12/455,589

Confirmation Number: 8087

Filing Date: Jun. 4, 2009

Name of applicant; Seongtai Song

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAMLISTING APPENDIX

Not Applicable

### BACKGROUND OF INVENTION

While driving, slow or fast, I've been frequently glancing at the RPM meter in the dash board, which shows the RPM of engine pistons. When the engine is idling, the arrow sign in RPM meter points the number around 0.75. In many cases the RPM arrow hovers well above 1.5-2.0 even when the accelerator pedal is released. Significant amount of gas can be saved if the RPM can quickly drops down to idling status and simultaneously surplus propulsive power of the forward moving vehicle can be transmitted to the vehicle tires when the vehicle is moving at a certain level of speed. Besides, having been anxious about the troubled U.S. auto industry, I've been mulling over the short-term, efficacious way to help U.S. brand cars compete with foreign brand cars.

### BRIEF SUMMARY OF THE INVENTION

While the engine and main transmission work as they are supposed to be separately, the gas consumption can be reduced through the combination of two ways;

Firstly, the built-in sensors mounted underneath the floor of the vehicle detect the current weight of the loads (people, cargo). As the vehicle starts moving, the computer connected to the sensor automatically calculates the entire weight of the vehicle by adding the weight of the loads to basic weight already entered in the computer and subsequently calculates the surplus propulsive power. The mechanical apparatus for the transmission of the surplus propulsive power delivers constantly propulsive power to the vehicle. When the certain level of propulsive power is generated out of the speed of the moving vehicle, the computer adjusts the supply amount of gas depending on the speed of the vehicle accordingly whenever the accelerator pedal is either being pushed down for higher speed or being released for slow-down.

Secondly, whenever the break pedal is pushed for a stop, the pushed break pedal Immediately disconnect s the transmission of propulsive power and the computer instantly adjusts the supply amount of the gas down to idling position. This also can save gas particularly when the vehicle is slowing down for a stop from high speed. While slowing down for a stop, if the driver wants to speed up the vehicle again, the released break pedal automatically reconnects the transmission of remaining propulsive power so the vehicle consume that much less gas for speeding up.

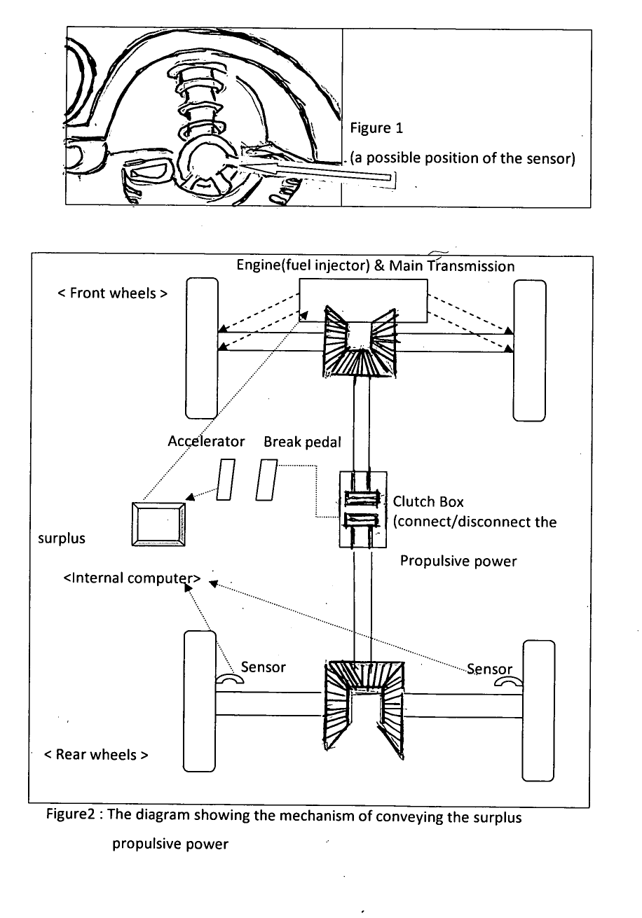

The sensors that detect the current weight of the loads can be installed on the opposite side of where the engine is placed as shown in FIG. 1. The sensors read the extent of contraction of the cushion coils conveying the weight of the loads to the tires.

### DETAILED DESCRIPTION OF THE INVENTION

The computer connected to the sensor calculates the surplus propulsive power based on the information transmitted from the sensors and the data already entered and programmed. Depending on the value of surplus propulsive power, the computer manipulates the fuel injector to adjust gas flow into the engine. When the accelerator pedal is released to maintain the current speed or to reduce the speed without having to push the break pedal, the computer also supply the gas at idling mode making the most of surplus propulsive power.

When the break pedal is pushed for slowing down or stopping , the surplus propulsive power is immediately disconnected in the Clutch Box and the computer reduce the gas supply to the engine at the idling level.

1. Vehicular fuel saving mechanical apparatus in the form of supplementary set of automobile transmission and computerized timely reduced fuel injection into combustion chamber.
